(19) United States
(12) Patent Application Publication
(10) Pub. No.: US 2023/0252270 A1
(43) Pub. Date: Aug. 10, 2023

(54) Method Of Data Selection And Anomaly Detection Based On Auto-Encoder Model

(71) Applicant: MakinaRocks Co., Ltd., Seoul (KR)

(72) Inventors: Yongsub LIM, Chungcheongnam-do (KR); Songsub LEE, Seoul (KR); Jongsun SHINN, Seoul (KR)

(73) Assignee: MakinaRocks Co., Ltd., Seoul (KR)

(21) Appl. No.: 18/095,426

(22) Filed: Jan. 10, 2023

(30) Foreign Application Priority Data
Feb. 4, 2022 (KR) 10-2022-0014690

(51) Int. Cl. G06N 3/0455

(52) U.S. Cl. CPC G06N 3/0455

(57) ABSTRACT

A method for calculating an anomaly score performed by a computing device including at least one processor is performed using an auto-encoder model to calculate an anomaly score based on the selection. The method includes calculating a reconstruction error for a plurality of data, based on an auto-encoder model; determining a reconstruction error for one or more data among the plurality of data as an exclusion object; and calculating the anomaly score based on the remaining reconstruction errors excluding the exclusion object, among reconstruction errors for the plurality of data.

### CROSS-REFERENCE TO RELATED APPLICATIONS

This application claims priority to and the benefit of Korean Patent Application No. 10-2022-0014690 filed in the Korean Intellectual Property Office on Feb. 4, 2022, the entire contents of which are incorporated herein by reference.

### TECHNICAL FIELD

The present disclosure relates to a technology of using an auto-encoder performed by a computing device, and more particularly, to a technology of calculating anomaly score using an auto-encoder model.

### BACKGROUND ART

An auto-encoder encodes input data into a lower dimensional latent space than the original input data and then decodes the encoded data to output reconstructed data.

In this case, the reconstructed data and the input data are compared to output a reconstruction error. For example, as the reconstruction error, the input data and the reconstructed data are considered as points in an n-dimensional coordinate space and a distance between two points is used as an indicator of the input and output difference.

In the meantime, when the anomaly detection is performed using the auto-encoder model, an object of the anomaly detection is to determine whether the input data includes anomaly input data. Accordingly, the auto-encoder model is trained to make the big difference of the reconstruction errors when normal data is input and the anomaly data is input.

As an example of utilizing the auto-encoder model for the anomaly detection, in an environment in which sensing values are derived by a plurality of sensors during a producing process of a product, such as a smart factory, sensing values generated during the process of producing the product may be used. When the defect occurs from the product, the cause of the defect may be found by tracking sensing values which deviate from a normal value, among the sensing values, by utilizing the environment. Further, when sensing values which cause the defects are detected, the producing process may be temporarily stopped. In this case, when sensing values which deviate from the normal data are input, the auto-encoder may output reconstruction errors different from that when the normal data is input. However, the speed of the model is inversely proportional to the number of sensors and is proportional to the capability of the processor so that when data corresponding to all the sensors is processed with a limited processor resource, the identification ability of the model is increased. However, it may be inefficient in terms of the cost because the capability of the processor supported thereby is necessary. In consideration of this, generally, when defects occur, an anomaly detecting method of considering sensors having a high causality as important sensors, training the anomaly detection model only with data of the important sensors, and inputting and using the data of the important sensor has been used. However, the above-mentioned method uses only sensing values output from the important sensor during the training process so that the data generated from the remaining sensors tends to be excluded from the model training. In contrast, data of sensors other than the important sensor also affects the anomaly detection accuracy. Accordingly, an anomaly score calculating method which increases an anomaly detecting accuracy by performing the learning in consideration of the change for all data and efficiently performs the anomaly detection even with a limited processor resource by an additional selecting process when an anomaly score is calculated is necessary.

### SUMMARY OF THE INVENTION

An object to be achieved by the present disclosure is to calculate an anomaly score based on the s election by using an auto-encode model. The object of the present disclosure is not limited to the above-mentioned objects and other objects and advantages of the present disclosure which have not been mentioned above can be understood by the following description and become more apparent from exemplary embodiments of the present disclosure. Further, it is understood that the objects and advantages of the present disclosure may be embodied by the means and a combination thereof in the claims.

In order to achieve the above-described objects, according to an aspect of the present disclosure, a method for calculating an anomaly score by a computing device including at least one processor is disclosed. A method for calculating an anomaly score, which is performed by a computing device including at least one processor includes: calculating a reconstruction error for a plurality of data, based on an auto-encoder model; determining a reconstruction error for one or more data among the plurality of data as an exclusion object; and calculating the anomaly score based on the remaining reconstruction errors excluding the exclusion object, among reconstruction errors for the plurality of data.

As an alternative exemplary embodiment, the plurality of data is associated with a plurality of attributes, the auto-encoder model is trained based on learning data for all the plurality of attributes, and the anomaly score is calculated based on some attributes among the plurality of attributes.

As an alternative exemplary embodiment, the determining as an exclusion object may include determining one or more reconstruction errors, among the plurality of reconstruction errors, as a first exclusion object, based on predetermined importance information.

As an alternative exemplary embodiment, the determining of one or more reconstruction errors, among the plurality of reconstruction errors, as a first exclusion object includes: a step of confirming an attribute for each of the plurality of reconstruction errors, a step of identifying an attribute which is determined to have a low importance, based on the predetermined importance information; and a step of determining one or more reconstruction errors having attributes determined to have a low importance as the first exclusion object.

As an alternative exemplary embodiment, the determining as an exclusion object further includes: a step of identifying one or more reconstruction errors which satisfy a predetermined range, among the plurality of reconstruction errors and determining the identified one or more reconstruction errors as a second exclusion object.

As an alternative exemplary embodiment, the determining of the identified one or more reconstruction errors as a second exclusion object includes: confirming an attribute for each of the plurality of reconstruction errors, identifying one or more reconstruction errors in a normal range, among the plurality of reconstruction errors, based on a predetermined normal range for each attribute, and determining the one or more reconstruction errors identified to be in the normal range, as the second exclusion object.

As an alternative exemplary embodiment, the determining as an exclusion object further includes: identifying one or more reconstruction errors which satisfy a predetermined range, among the plurality of data and determining the identified one or more reconstruction errors as a second exclusion object, and the calculating of an anomaly score includes calculating the anomaly score based on the remaining reconstruction errors excluding the first exclusion object and the second exclusion object, among the plurality of reconstruction errors.

As an alternative exemplary embodiment, the reconstruction error is based on a difference between data input to the auto-encoder model and data output from the auto-encoder model.

In order to achieve the above-described objects, according to an aspect of the present disclosure, a computer program stored in a computer readable storage medium is disclosed. The computer program causes one or more processors to perform an operation for calculating an anomaly score when the computer program is executed by the one or more processors and the operations include: an operation of calculating a reconstruction error for a plurality of data, based on an auto-encoder model; an operation of determining one or more reconstruction errors, among the plurality of reconstruction errors, as an exclusion object; and an operation of calculating the anomaly score based on the remaining reconstruction errors excluding the exclusion object, among the reconstruction errors.

In order to achieve the above-described objects, according to an aspect of the present disclosure, the device includes: a processor including one or more cores; and a memory and the processor is configured to calculate a reconstruction error for a plurality of data, based on an auto-encoder model, determine one or more reconstruction errors, among the plurality of reconstruction errors, as an exclusion object; and calculate the anomaly score based on the remaining reconstruction errors excluding the exclusion object, among the plurality of reconstruction errors.

According to the exemplary embodiments of the present disclosure, an auto-encoder model which is trained by utilizing unselected data to calculate an anomaly score and data for calculating an anomaly score is selected and used.

### BRIEF DESCRIPTION OF THE DRAWINGS

FIG. 1 is a block diagram of a computing device for calculating an anomaly score using an auto-encoder model according to an exemplary embodiment of the present disclosure;

FIG. 2 is a schematic view illustrating a method of generating a reconstruction error by a general auto-encoder model, prior to description of an exemplary embodiment of the present disclosure;

FIG. 3 is a schematic view illustrating a network function according to an exemplary embodiment of the present disclosure;

FIG. 4 is a schematic view illustrating a method of calculating an anomaly score by selecting a reconstruction error output by a processor using an auto-encoder model according to an exemplary embodiment of the present disclosure;

FIG. 5 is a schematic view illustrating a method for calculating an anomaly score by selecting a reconstruction error based on predetermined information according to an exemplary embodiment of the present disclosure;

FIG. 6 is a schematic view illustrating a method for calculating an anomaly score by a processor including a first exclusion object determining module according to an exemplary embodiment of the present disclosure;

FIG. 7 is a schematic view illustrating a method for calculating an anomaly score by a processor including a second exclusion object determining module according to an exemplary embodiment of the present disclosure;

FIG. 8 is a schematic view illustrating a method for calculating an anomaly score by a processor including a first exclusion object determining module and a second exclusion object determining module according to an exemplary embodiment of the present disclosure;

FIG. 9 is a flowchart illustrating a method for calculating an anomaly score using an auto-encoder model by a processor according to an exemplary embodiment of the present disclosure; and

FIG. 10 illustrates a simple and general schematic view of an exemplary computing environment in which exemplary embodiments of the present disclosure are embodied.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing procedure executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, configurations, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein. In the present disclosure, a network function, an artificial neural network, and a neural network may be used to be exchangeable.

In the present disclosure, a reconstruction error represents a numerical value of a difference of data input to an auto-encoder model and output data. Generally, the reconstruction error is understood to consider the input data and the reconstructed data as points in an n-dimensional coordinate space and use a distance between two points as an indicator of the input and output difference. However, the method for calculating a reconstruction error is not limited thereto.

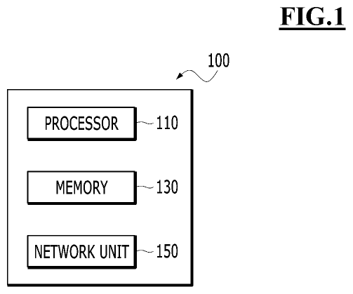

FIG. 1 is a block diagram of a computing device for calculating an anomaly score using an auto-encoder model according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. According to an exemplary embodiment of the present disclosure, the processor 110 may perform a calculation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to several embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

In the present disclosure, the network unit 110 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

The techniques described herein may be used not only in the networks mentioned above, but also in other networks.

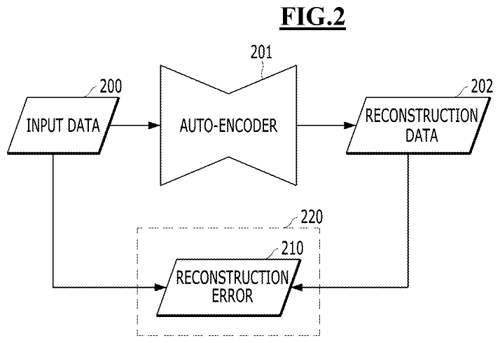

FIG. 2 is a schematic view illustrating a method of generating a reconstruction error by a general auto-encoder model, prior to description of an exemplary embodiment of the present disclosure.

A model structure represented in FIG. 2 is one of examples for describing a reconstruction error which is generally expressed and the exemplary embodiment of the present disclosure may be understood by those skilled in the art that the auto-encoder structure and the method for outputting the reconstruction error are not limited thereto.

Referring to FIG. 2, input data 200, an auto-encoder model 201, reconstruction data 202, and a reconstruction error 210 are illustrated. In this case, a calculation process 220 for deriving a difference of the input data 200 and the reconstruction data 202 is also illustrated. Referring to FIG. 2, the auto-encoder model 201 may generate a feature value by dimension reduction. Further, during the process of extracting a feature value, a non-linear relationship of dimensions of the input data 200 may be considered. Further, the auto-encoder model 201 compresses data into a space with a lower dimension than that of original input data 200 and during the process of reconstructing the original data to output the reconstruction data 202, a feature of learning data is extracted to be in a latent space. In this case, an expressive form of data in the latent space is referred to as a latent variable and the auto-encoder model 201 is trained by the process of minimizing a data difference between the input data 200 and the reconstruction data 202. In this case, the data difference between the input data 200 and the reconstruction data 202 may be a reconstruction error 210. That is, a person of ordinary skill in the art may know that the reconstruction error is affected by the dataset for training and a type of input data. Further, it is understood that the reconstruction error is affected by a number of training and is affected by types of an encoder which performs the compression and a decoder which performs the reconstruction.

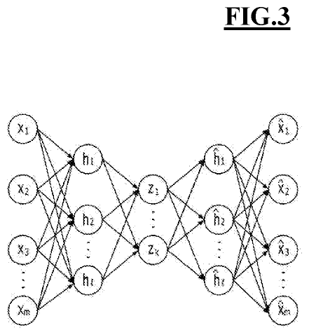

FIG. 3 is a schematic diagram illustrating a network function according to an exemplary embodiment of the present disclosure.

Throughout the present specification, a computation model, the neural network, a network function, and the neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

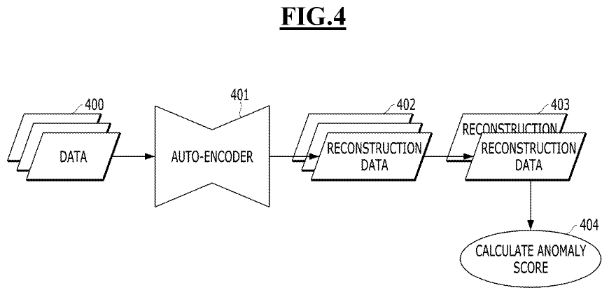

FIG. 4 is a schematic view illustrating a method of calculating an anomaly score by selecting a reconstruction error output by a processor using an auto-encoder model according to an exemplary embodiment of the present disclosure. (In this case, the reconstruction error is understood to represent a numerical value of a difference of data input to the auto-encoder model and data output from the auto-encoder model.)

Referring to FIG. 4, an exemplary embodiment of a method for calculating an anomaly score by selecting a reconstruction error based on an auto-encoder model by the processor 110 of the present disclosure is disclosed. The processor 110 may input a plurality of data 400 to the auto-encoder model 401. Further, the processor 110 calculates a plurality of reconstruction errors 402 for the plurality of data 400, based on the plurality of data 400, using the auto-encoder model 401. In this case, the reconstruction errors 402 may correspond to the plurality of data 400 and the reconstruction errors include a reconstruction error which is calculated based on corresponding data value using the auto-encoder model 401. Further, the processor 110 may determine one or more reconstruction errors 402 among the plurality of data 400 as exclusion objects. For example, reconstruction errors RE_1, RE_2, and RE_3 corresponding to each data may be output based on data D_1, D_2, and D_3, using the auto-encoder model. Next, the processor 110 may exclude at least one of the reconstruction errors RE_1, RE_2, and RE_3. As additional example, the processor 110 may determine the reconstruction error 402 as an exclusion object using predetermined information. In this case, the predetermined information may include a probability value, a binary value, and a real number having a category of whether it is important and a normal range. Further, the predetermined information may include a conditional statement or a conditional equation. Further, the processor 110 calculates the anomaly score (404), based on remaining reconstruction errors 403 excluding the exclusion object, among the reconstruction errors 402 for the plurality of data 400.

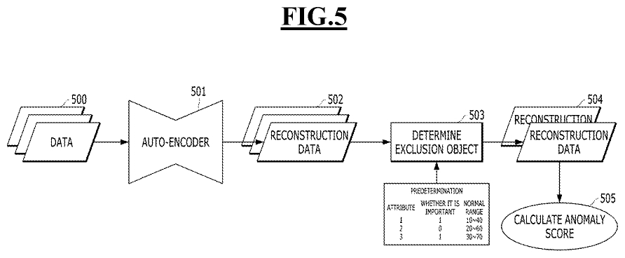

FIG. 5 is a schematic view illustrating a method for calculating an anomaly score by selecting a reconstruction error based on predetermined information according to an exemplary embodiment of the present disclosure. The schematic view further illustrates an exclusion object determining module 503 and the predetermined information 510 to describe the method for determining one or more reconstruction errors 402 as an exclusion object, in the exemplary embodiment described above with reference to FIG. 4.

Referring to FIG. 5, an exemplary embodiment of a method for calculating an anomaly score by selecting a reconstruction error based on an auto-encoder model by the processor 110 of the present disclosure is disclosed. The processor 110 may input a plurality of data 500 to the auto-encoder model 501. Further, the processor 110 calculates a plurality of reconstruction errors 502 for the plurality of data 500, based on the plurality of data 500, using the auto-encoder model 501. In this case, the reconstruction errors 502 may correspond to the plurality of data 500 and the reconstruction errors include a reconstruction error which is calculated based on corresponding data value using the auto-encoder model 501. Further, the processor 110 determines one or more reconstruction errors 502 among the plurality of reconstruction errors 502 as exclusion objects, using an exclusion object determining module. In this case, the exclusion object determining module determines the object to be excluded based on the predetermined information 510 and the predetermined information includes information for determining the exclusion object based on a unique attribute for identifying each data and the reconstruction error.

For example, the processor outputs a reconstruction error 502 having an attribute “a” based on data having an attribute “a” using the auto-encoder model 501 and determines whether it is an object to be excluded, based on the reconstruction error 502 having the attribute “a” using the exclusion object determining module. In this case, whether it is an object to be excluded may be determined based on information about the attribute “a” included in the predetermined information 510.

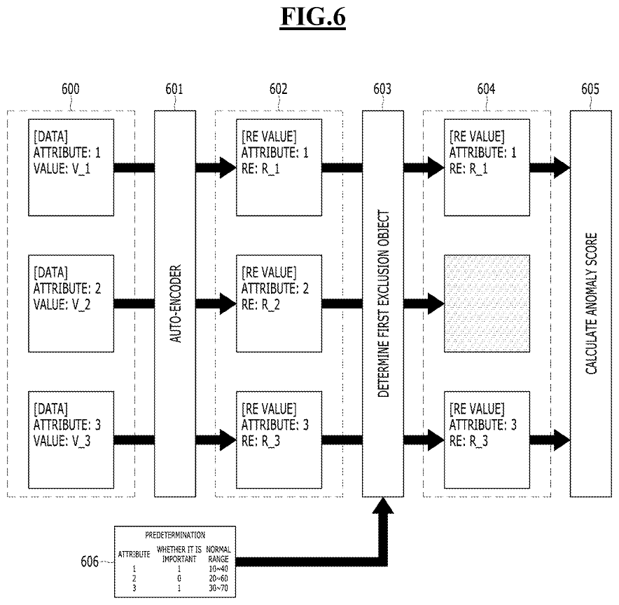

FIG. 6 is a schematic view illustrating a method for calculating an anomaly score by a processor based on a first exclusion object determining module according to an exemplary embodiment of the present disclosure. Specifically, the plurality of data 600 represented in FIG. 6 may be classified by included attributes and each data includes an attribute and a value. Further, the plurality of reconstruction errors (RE values) 602 may inherit the attributes from the data. Further, the reconstruction errors 604 from which the first exclusion object is excluded is represented using the plurality of reconstruction errors 602 based on the first exclusion object determining module 603. Further, the predetermined information 606 referenced by the first exclusion object determining module 603 is represented. In this case, the predetermined information 606 includes information about whether it is important and a normal range used to classify the exclusion objects according to each attribute.

Referring to FIG. 6, an exemplary embodiment of a method for calculating an anomaly score based on the first exclusion object determining module by the processor 110 of the present disclosure is disclosed. The processor 110 calculates the reconstruction errors 602 for the plurality of data 600, based on the auto-encoder model 601. Further, the processor 110 may determine the first exclusion object based on the plurality of reconstruction errors 602 and the predetermined information 606 using the first exclusion object determining module 603. Further, the processor 110 calculates the anomaly score based on the reconstruction error 604 excluding the determined first exclusion object, using the anomaly score calculating module 605. In this case, the first exclusion object determining module 603 confirms each attribute of the plurality of reconstruction errors 604 and identifies an attribute which is determined to have a low importance, based on whether it is important, which it is determined in advance, corresponding to the plurality of reconstruction errors 604 to determine the reconstruction error as a first exclusion object.

For example, when it is assumed that there are three reconstruction errors 602 of {attribute: 1, RE: 10}, {attribute: 2, RE: 75}, and {attribute: 3, RE: 12}, the predetermined information 606 may be {attribute: 1, importance: 1}, {attribute: 2, importance: 0}, and {attribute: 3, importance: 0}. In this case, when it is assumed that three reconstruction errors are input to the first exclusion object determining module 603, the processor 110 may determine {attribute: 2, RE 75} which is determined that it is not important, based on the first exclusion object determining module 703 and the predetermined information 706 as a first exclusion object.

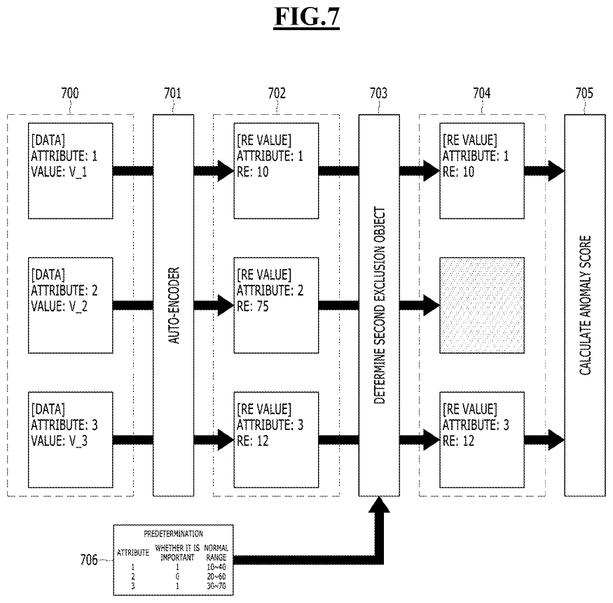

FIG. 7 is a schematic view illustrating a method for calculating an anomaly score by a processor including a second exclusion object determining module according to an exemplary embodiment of the present disclosure. Specifically, the plurality of data 700 of FIG. 7 may be classified by included attributes and each data includes an attribute and a value. Further, the plurality of reconstruction errors (RE values) 702 may inherit the attributes from the data. Further, the reconstruction errors 704 from which the second exclusion object is excluded is represented using the plurality of reconstruction errors 702 based on the second exclusion object determining module 704. Further, the predetermined information 706 referenced by the first exclusion object determining module 703 is represented. In this case, the predetermined information 706 includes information about whether it is important and a normal range according to each attribute used to classify the exclusion objects.

Referring to FIG. 7, an exemplary embodiment of a method for calculating an anomaly score based on the second exclusion object determining module by the processor 110 of the present disclosure is disclosed. The processor 110 may calculates the reconstruction error 702 based on a plurality of data 700 using the auto-encoder model 701. Further, the processor 110 determines the second exclusion object using the second exclusion object determining module 703 based on the reconstruction error 702 and the predetermined information 706 and outputs a reconstruction error 704 excluding the determined second exclusion object. Further, the processor 110 calculates the anomaly score based on the reconstruction error 704 from which the reconstruction error is partially excluded, using the anomaly score calculating module 705. In this case, the processor 110 identifies attributes of the plurality of reconstruction errors 704 using the second exclusion object determining module 703 and determines a reconstruction error 702 of data 700 which is determined to be in the normal range, based on the predetermined normal range corresponding to the attribute, as a second exclusion object.

For example, it is assumed that there are three data 700 of {attribute: 1, value: V_1}, {attribute: 2, value: V_2}, and {attribute: 3, value: V_3} and V_1, V_2, and V_3 are “30.5”, “60”, and “−10”, respectively. Further, it is assumed that the predetermined information 706 is {attribute: 1, normal range_maximum: 25, normal range_minimum: 11}, {attribute: 2, normal range_maximum: 50, normal range_minimum: 80}, and {attribute: 3, normal range_maximum: 10, normal range_minimum: 0}. In this case, when it is assumed three reconstruction errors 702 generated using the auto-encoder model 701 are input to the second exclusion object determining module 703 based on three data 700, the processor 110 determines the reconstruction error {attribute: 2, RE:75} for data (for example, data having the normal range_minimum of 50, maximum of 80, the attribute of 2, and the value of 60) within the normal range as the second exclusion object, based on three reconstruction errors 702 and the predetermined information 706, using the second exclusion object determining module 703.

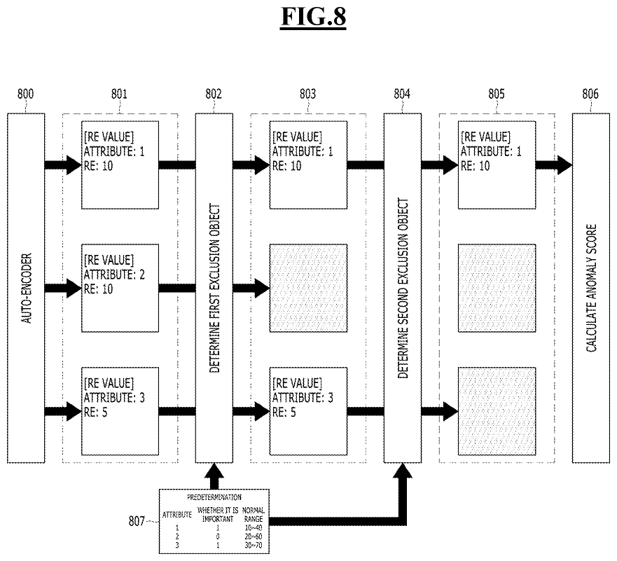

FIG. 8 is a schematic view illustrating a method for calculating an anomaly score by a processor including a first exclusion object determining module and a second exclusion object determining module according to an exemplary embodiment of the present disclosure. Specifically, in FIG. 8, a reconstruction error (RE value) 801 calculated based on each data is represented. In this case, the reconstruction error 801 may include an attribute inherited from each data. Further, the reconstruction errors 803 from which the first exclusion object is excluded is represented using the plurality of reconstruction errors 801 based on the first exclusion object determining module 802. Further, reconstruction errors 805 from which both the first exclusion object and the second exclusion object generated based on the second exclusion object determining module 804 are excluded are represented, using the plurality of reconstruction errors 803 from which the first exclusion object is excluded. Further, the predetermined information 807 used by the first exclusion object determining module 802 and the second exclusion object determining module 804 to classify the exclusion object is represented. In this case, the predetermined information 807 includes information about whether it is important according to each attribute and a normal range.

Referring to FIG. 8, an exemplary embodiment of a method for calculating an anomaly score based on the first exclusion object determining module and the second exclusion object determining module by the processor 110 of the present disclosure is disclosed. The processor 110 may calculates the reconstruction errors 801 based on a plurality of data using the auto-encoder model 800. Further, the processor 110 may determine one or more reconstruction errors 801 among the plurality of reconstruction errors 801 as the first exclusion object based on the first exclusion object determining module 802 and the predetermined information 807. Further, the processor 110 determines the second exclusion object using the second exclusion object determining module 804 and the predetermined information 807 based on the reconstruction error 803 from which the first exclusion object is excluded and outputs a reconstruction error 805 from which the determined second exclusion object is further excluded. Further, the processor 110 may calculate an anomaly score based on the reconstruction errors from which both the first exclusion object and the second exclusion object are excluded, among the plurality of reconstruction errors.

For example, when the processor 110 inputs three reconstruction errors represented by {attribute: 1, RE: 10}, {attribute: 2, RE: 10}, and {attribute: 3, RE: 5} to the first exclusion object determining module 802, the first exclusion object determining module 802 determines {attribute: 2, RE:10} having a relatively low importance based on the predetermined information {attribute: 2, importance: 0} as the first exclusion object. Further, when the processor 110 inputs the remaining reconstruction errors 803 represented by {attribute: 1, RE: 10} and {attribute: 3, RE: 5} from which the first exclusion object is excluded, to the second exclusion object determining module 804, the second exclusion object determining module 802->804 determines the reconstruction error {attribute: 3, RE: 5} based on the predetermined information {attribute: 3, normal range: 30 to 70} as the second exclusion object. Finally, the processor 110 may calculate an anomaly score based on the reconstruction errors 805 from which both the first exclusion object and the second exclusion object are excluded, among the plurality of reconstruction errors.

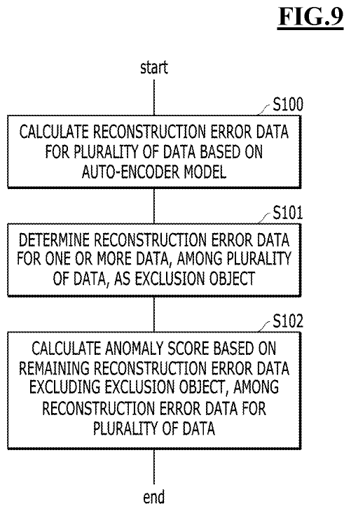

FIG. 9 is a flowchart illustrating a method for calculating an anomaly score using an auto-encoder model by a processor according to an exemplary embodiment of the present disclosure.

Referring to FIG. 9, an exemplary embodiment of a method for calculating an anomaly score by selecting an output reconstruction error using an auto-encoder model executed by the processor 110 of the present disclosure is disclosed. The method may include a step S100 of calculating reconstruction errors for a plurality of data based on an auto-encoder model by the processor 110, a step S101 of determining a reconstruction error for one or more data, among the plurality of data, as an exclusion object, by the processor 110, and a step S102 of calculating the anomaly score based on the remaining reconstruction errors excluding the exclusion object, among the reconstruction errors for the plurality of data, by the processor 110.

In this case, the plurality of data is associated with the plurality of attributes and the auto-encoder model is trained based on the learning data for all the plurality of attributes and the anomaly score is calculated based on some attributes of the plurality of attributes.

As an additional exemplary embodiment, the step S101 of determining as an exclusion object may include a step of determining one or more reconstruction errors, among the plurality of reconstruction errors, as a first exclusion object, based on predetermined importance information.

In this case, the step of determining one or more reconstruction errors, among the plurality of reconstruction errors, as a first exclusion object includes: a step of confirming an attribute for each of the plurality of reconstruction errors, a step of identifying an attribute which is determined to have a low importance, based on the predetermined importance information; and a step of determining one or more reconstruction errors having attributes determined to have a low importance as the first exclusion object.

As an additional exemplary embodiment, the step S101 of determining as an exclusion object further includes a step of identifying one or more reconstruction errors which satisfy a predetermined range, among the plurality of reconstruction errors and determining the identified one or more reconstruction errors as a second exclusion object.

In this case, the step of determining the identified one or more reconstruction errors as a second exclusion object includes: a step of confirming an attribute for each of the plurality of reconstruction errors, a step of identifying one or more reconstruction errors in a normal range, among the plurality of reconstruction errors, based on a predetermined normal range for each attribute, and a step of determining the one or more reconstruction errors identified to be in the normal range, as the second exclusion object.

As an additional exemplary embodiment, the step S101 of determining as an exclusion object further includes a step of identifying one or more reconstruction errors which satisfy a predetermined range, among the plurality of data and determining the identified one or more reconstruction errors as a second exclusion object, and the step of calculating an anomaly score includes a step of calculating the anomaly score based on the remaining reconstruction errors excluding the first exclusion object and the second exclusion object, among the plurality of reconstruction errors.

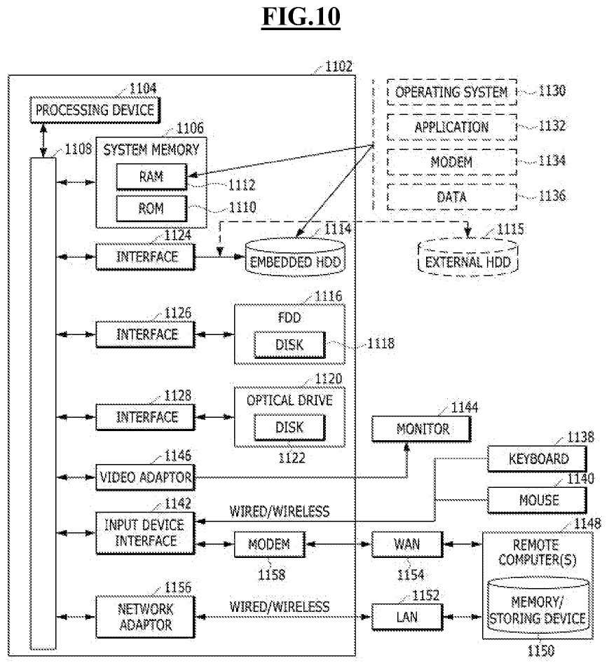

FIG. 10 is a simple and general schematic diagram illustrating an example of a computing environment in which the embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method for calculating an anomaly score performed by a computing device including at least one processor, the method comprising:
calculating a reconstruction error for a plurality of data, based on an auto-encoder model;
determining a reconstruction error for one or more data among the plurality of data as an exclusion object; and
calculating the anomaly score based on the remaining reconstruction errors, excluding the exclusion object among reconstruction errors for the plurality of data.

2. The method of claim 1, wherein the plurality of data is associated with a plurality of attributes, the auto-encoder model is trained based on learning data for all the plurality of attributes, and the anomaly score is calculated based on some attributes among the plurality of attributes.

3. The method of claim 1, wherein the determining as an exclusion object includes:
determining one or more reconstruction errors, among the plurality of reconstruction errors, as a first exclusion object, based on predetermined importance information.

4. The method of claim 3, wherein the determining of one or more reconstruction errors, among the plurality of reconstruction errors, as a first exclusion object includes:
confirming an attribute for each of the plurality of reconstruction errors,
identifying an attribute which is determined to have a low importance, based on the predetermined importance information; and
determining one or more reconstruction errors having attributes determined to have a low importance as the first exclusion object.

5. The method of claim 1, wherein the determining as an exclusion object further includes:
identifying one or more reconstruction errors which satisfy a predetermined range, among the plurality of reconstruction errors and determining the identified one or more reconstruction errors as a second exclusion object.

6. The method of claim 5, wherein the determining of the identified one or more reconstruction errors as a second exclusion object includes:
confirming an attribute for each of the plurality of reconstruction errors,
identifying one or more reconstruction errors in a normal range, among the plurality of reconstruction errors, based on a predetermined normal range for each attribute, and
determining the one or more reconstruction errors identified to be in the normal range, as the second exclusion object.

7. The method of claim 3, wherein the determining as an exclusion object further includes:
identifying one or more reconstruction errors which satisfy a predetermined range, among the plurality of data and determining the identified one or more reconstruction errors as a second exclusion object, and
the calculating of an anomaly score includes:
calculating the anomaly score based on the remaining reconstruction errors excluding the first exclusion object and the second exclusion object, among the plurality of reconstruction errors.

8. The method of claim 1, wherein the reconstruction error is based on a difference between data input to the auto-encoder model and data output from the auto-encoder model.

9. A computer program stored in a non-transitory computer readable storage medium wherein the computer program executes the following operations for calculating an anomaly score when the computer program is executed by the one or more processors, the operations include:
an operation of calculating a reconstruction error for a plurality of data, based on an auto-encoder model;
an operation of determining one or more reconstruction errors, among the plurality of reconstruction errors, as an exclusion object; and
an operation of calculating the anomaly score based on the remaining reconstruction errors excluding the exclusion object, among reconstruction errors.

10. A computing device, comprising:
a processor including one or more cores; and
a memory;
wherein the processor is configured to calculate a reconstruction error for a plurality of data, based on an auto-encoder model, determine one or more reconstruction errors, among the plurality of reconstruction errors, as an exclusion object; and calculate the anomaly score based on the remaining reconstruction errors excluding the exclusion object, among the plurality of reconstruction errors.
